(19) United States
(12) Patent Application Publication
(10) Pub. No.: US 2023/0401794 A1
(43) Pub. Date: Dec. 14, 2023

(54) VIRTUAL REALITY NETWORK PERFORMER SYSTEM AND CONTROL METHOD THEREOF

(71) Applicant: SPEED 3D Inc., Taipei City (TW)

(72) Inventors: Li-Chuan Chiu, Taipei City (TW); Jui-Chun Chung, Taipei City (TW); Yi-Ping Cheng, Taipei City (TW)

(73) Assignee: SPEED 3D Inc., Taipei City (TW)

(21) Appl. No.: 17/882,625

(22) Filed: Aug. 8, 2022

(30) Foreign Application Priority Data
Jun. 14, 2022 (TW) 111122253

(51) Int. Cl. G06T 19/00

(52) U.S. Cl. CPC G06T 19/00; G06T 2219/024

(57) ABSTRACT

A virtual reality network performer system includes a scene setup module, a recording module and a processing module. The scene setup module receives a scene setup instruction inputted by a performer in order to set a plurality of environmental parameters. The recording module receives a voice data, a body motion data and a face data of the performer. The processing module performs a voice changing for the voice data to generate a voice changing result, and analyzes the body motion data and the face data to generate a body motion and a face expression. Then, the processing module saves the environmental parameters, the voice changing result, the body motion and the face expression in a cloud storage module in order to form a cloud data.

### BACKGROUND OF THE INVENTION

### 1. Field of the Invention

The present invention relates to a network performer system, in particular to a virtual reality network performer system. The present invention further relates the control method of the virtual reality network performer system.

### 2. Description of the Prior Art

Generally speaking, with the popularization of Internet, YouTubers and freelance journalists become popular jobs. However, with the development of the concept of the metaverse, virtual reality network performers may become the development trend in the future. The difference between a conventional network performer and a virtual reality network performer is that the virtual reality network performer can use a virtual character model generated using computer graphics to appear in his/her video programs in order to entertain the viewers. Any one of the viewers can watch the video program provided by the virtual reality network performer via a virtual reality device, such as a virtual reality headset. However, there is currently no an effective system for a virtual reality network performer to efficiently make a video program for the viewers to watch.

### SUMMARY OF THE INVENTION

One embodiment of the present invention provides a virtual reality network performer system, which includes a scene setup module, a recording module and a processing module. The scene setup module receives a scene setup instruction inputted by a performer in order to set a plurality of environmental parameters. The recording module receives a voice data, a body motion data and a face data of a performer. The processing module performs a voice changing for the voice data to generate a voice changing result, and analyzes the body motion data and the face data to generate a body motion and a face expression. Then, the processing module saves the environmental parameters, the voice changing result, the body motion and the face expression in a cloud storage module in order to form a cloud data.

In one embodiment, the environmental parameters include a background, a character model, a background music, an incidental music, a sound effect, a special effect, the location of a viewer, the viewing angle of the viewer and an interaction mode.

In one embodiment, when the processing module determines that any one of the voice changing result, the body motion and the face expression conforms to the special effect triggering condition of the character model, the processing module generates a visual special effect corresponding to the special effect triggering condition.

In one embodiment, the system further includes a program setup module, a data receiving module and a 3-dimensional (3D) model re-mapping module. The program setup module receives a program setup instruction, and the data receiving module receives the cloud data from the cloud storage module according to the program setup instruction. The 3D model re-mapping module integrates a 3D model with the cloud data so as to generate a first program data.

In one embodiment, the system further includes a program selecting module and a video receiving module. The program selecting module receives a program selecting instruction. The video receiving module receives the cloud data from the cloud storage module according to the program selecting instruction in order to generate a second program data.

Another embodiment of the present invention provides a control method for a virtual reality network performer system, which includes the following steps: receiving a scene setup instruction inputted by a performer by a scene setup module so as to set a plurality of environmental parameters; receiving a voice data, a body motion data and a face data of the performer by a recording module; performing a voice changing for the voice data by a processing module in order to generate a voice changing result; analyzing the body motion data and the face data by the processing module so as to generate a body motion and a face expression; and saving the environmental parameters, the voice changing result, the body motion and the face expression in a cloud storage module by the processing module in order to form a cloud data.

In one embodiment, the environmental parameters include a background, a character model, a background music, an incidental music, a sound effect, a special effect, the location of a viewer, the viewing angle of the viewer and an interaction mode.

In one embodiment, the control method further includes the following step: generating a visual special effect corresponding to a special effect triggering condition of the character model by the processing module when any one of the voice changing result, the body motion and the face expression conforms to the special effect triggering condition.

In one embodiment, the control method further includes the following steps: receiving a program setup instruction by a program setup module; receiving the cloud data from the cloud storage module according to the program setup instruction by a data receiving module; and integrating a 3D model with the cloud data by a 3D model re-mapping module so as to generate a first program data.

In one embodiment, the control method further includes the following steps: receiving a program setup instruction by a program setup module; and receiving the cloud data from the cloud storage module according to the program setup instruction by a video receiving module in order to generate a second program data.

The virtual reality network performer system and the control method thereof in accordance with the embodiments of the present invention may have the following advantages:
(1) In one embodiment of the present invention, the virtual reality network performer system can receive the scene setup instruction inputted by a performer in order to set a plurality of environmental parameters, and receive the voice data, the body motion data and the face data of the performer in order to generate a voice changing result, a body motion and a face expression. Then, the virtual reality network performer system saves the environmental parameters, the voice changing result, the body motion and the face expression in the cloud storage module in order to form a cloud data. Via the above operational mechanism, the performer can swiftly and efficiently make a program via the virtual reality network performer system, so the system can satisfy actual requirements.
(2) In one embodiment of the present invention, the functional modules of the virtual reality network performer system can provide the proper contents for the performer to freely design his/her programs so as to meet the needs of making different types of programs. Therefore, the system can be more convenient in use and comprehensive in application.
(3) In one embodiment of the present invention, the virtual reality network performer system has a 3-dimensional (3D) model re-mapping module, which can integrate a 3D model with the cloud data so as to generate a program data. As a result, the voice, body motion and face expression of the performer can be effectively integrated with the 3D model in order to achieve great visual effect and improve the experiences of the VIP viewers.
(4) In one embodiment of the present invention, the virtual reality network performer system has a program setup module for the VIP viewers to set performer, donation mode, cheering sound effect, camera mode, screenshot, text outputting, voice outputting, virtual hand interaction mode, location of viewer, sound effect, sound volume, etc. Therefore, the system can provide more functions for the VIP viewers, which can further improve the experiences of the VIP viewers.
(5) In one embodiment of the present invention, the virtual reality network performer system can provide additional visual special effects for the character model selected by the performer. In this way, the performer can make a body motion conforming to the special effect trigging condition of the character mode selected by the performer with a view to trigger the visual special effect corresponding thereto, which can significantly increase the entertainment of the program.
(6) In one embodiment of the present invention, the virtual reality network performer system can provide a special operational mechanism for the performer to swiftly and efficiently make his/her programs, which can meet the development trend in the future and the demand of this industry. Accordingly, the system can have high commercial value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a virtual reality network performer system in accordance with one embodiment of the present invention.

FIG. 2 is a block diagram of a virtual reality network performer system in accordance with another embodiment of the present invention.

FIG. 3 is a flow chart of a control method of a virtual reality network performer system in accordance with one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

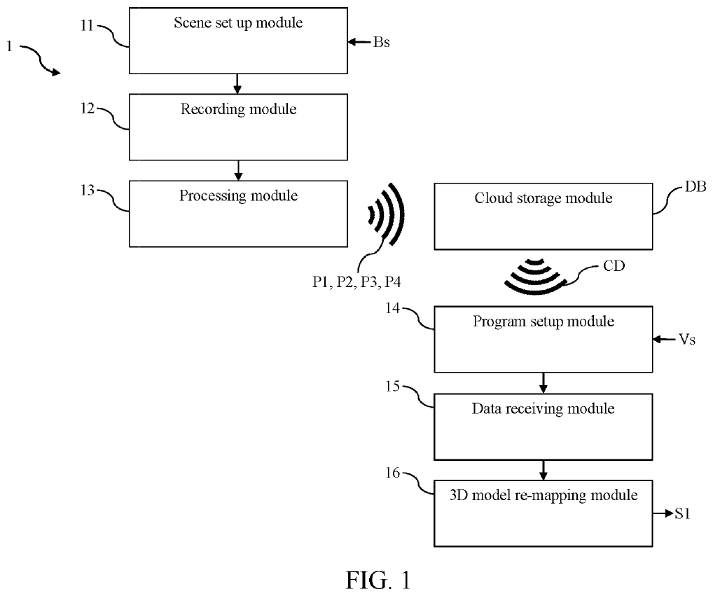

Please refer to FIG. 1, which is a block diagram of a virtual reality (VR) network performer system in accordance with one embodiment of the present invention. As shown in FIG. 1, the virtual reality network performer system 1 includes a scene setup module 11, a recording module 12, a processing module 13, a program setup module 14, a data receiving module 15 and a 3-dimensional (3D) model re-mapping module 16. The above modules can be implemented entirely in hardware, entirely in software or in an implementation containing both hardware and software elements. Each of the modules can be also an independent hardware element or an independent software element.

The scene setup module 11 receives a scene setup instruction Bs inputted by a performer via his/her electronic device (e.g., smart phone, tablet computer, laptop computer, personal computer, virtual reality headset, augmented reality headset, etc.) in order to set a plurality of environmental parameters P1. In one embodiment, the environmental parameters P1 includes one or more of background, character model, background music, incidental music, sound effect, special effect, location of viewer, viewing angle of viewer and interaction mode.

The recording module 12 receives the voice data, the body motion data and the face data of the performer. The performer can transmit a video via his/her electronic device (e.g., smart phone, tablet computer, laptop computer, personal computer, virtual reality headset, augmented reality headset, etc.) to the recording module 12, such that the receiving module 12 can obtain the voice data, the body motion data and the face data of the performer.

The processing module 13 performs voice changing for the voice data to generate a voice changing result P2, and analyzes the body motion data and the face data to generate a body motion P3 and a face expression P4. Then, the processing module 13 saves the environmental parameters P1, the voice changing result P2, the body motion P3 and the face expression P4 in a cloud storage module DB in order to form a cloud data CD.

In addition, the processing module 13 can provide some additional special effects according to the character model (one of the environmental parameters P1) selected by the performer. In this embodiment, when the processing module 13 determines that any one of the voice changing result P2, the body motion P3 and the face expression P4 conforms to the special effect triggering condition of the aforementioned character model, the processing module 13 generates a visual special effect corresponding to the special effect triggering condition. The visual special effect can be an environmental visual effect and/or a character model visual effect. For instance, the performer selects the “the superman” to be his/her character model; the special effect triggering condition of this character model (the superman) is the body motion “put two hands on the waist” and the visual special effect corresponding thereto is “the stage spotlight highlights the superman” (environmental visual effect). In this case, when the processing module 13 determines that the body motion P3 includes “put two hands on the waist”, the processing module 13 generates the visual special effect “the stage spotlight highlights the superman”. For example, the performer selects the “the God of Wealth” to be his/her character model; the special effect triggering condition of this character model (the God of Wealth) is the body motion “throw the hands open” and the visual special effect corresponding thereto is “money rain” (environmental visual effect). In this case, when the processing module 13 determines that the body motion P3 includes “throw the hands open”, the processing module 13 generates the visual special effect “money rain”. For instance, the performer selects the “the bear” to be his/her character model; the special effect triggering condition of this character model (the bear) is the face expression “open the mouth” and the visual special effects corresponding thereto are “the bear breathes fire” (character model visual effect) and “volcanic eruption” (environmental visual effect). In this case, when the processing module 13 determines that the face expression P4 includes “open the mouth”, the processing module 13 generates the visual special effects “the bear breathes fire” and “volcanic eruption”. The above visual special effects may serve as a part of the cloud data CD.

The program setup module 14 receives a program setup instruction Vs inputted by a VIP viewer (the user obtains the VIP qualification by buying the VIP account) via his/her electronic device (e.g., smart phone, tablet computer, laptop computer, personal computer, virtual reality headset, augmented reality headset, etc.). In one embodiment, the VIP viewer can set one or more of performer, donation mode, cheering sound effect, camera mode, screenshot, text outputting, voice outputting, virtual hand interaction mode, location of viewer, sound effect, sound volume via the program setup instruction Vs. Location of viewer means the location of the viewer in the virtual performance stage and the viewer's visual angle. Virtual hand interaction mode means the way of the viewer in the virtual performance stage interacting with the performer.

The data receiving module 15 receives the program setup instruction Vs and receives the cloud data CD, from the cloud storage module DB, of the performer designated by the program setup instruction Vs.

The 3D model re-mapping module integrates a 3D model with the cloud data CD so as to generate a first program data S1 and transmits the first program data S1 to the electronic device of the VIP viewer (e.g., VR headset, AR headset, etc.) in order to display the first program data S1. Therefore, the VIP viewer can watch the first program data S1 via his/her electronic device. The first program data S1 can be a live broadcast or a recorded program. Besides, the above 3D model may be an animal, a cartoon character, a movie character or other virtual characters. The 3D model re-mapping module 16 integrates the 3D model with the body motion P3 and the face expression P4, saved in the cloud data CD, of the performer. In this way, the virtual character generated by the 3D model re-mapping module 16 can be lifelike, which can achieve excellent visual effect.

In addition, as set forth above, the VIP viewer can set one or more of performer, donation mode, cheering sound effect, camera mode, screenshot, text outputting, voice outputting, virtual hand interaction mode, location of viewer, sound effect, sound volume, etc., via his/her electronic device. Accordingly, the virtual reality network performer system 1 can provide the VIP viewer the function of customizing the first program data S1 and the interaction modes, which can effectively improve the experience of the VIP viewer watching the performer's program.

As previously stated, the virtual reality network performer system 1 according to this embodiment can receive the scene setup instruction Bs so as to set the environmental parameters P1. Further, the virtual reality network performer system 1 can receive the voice data, body motion data and the face data to generate the voice changing result P2, the body motion P3 and the face expression P4 according to the voice data, the body motion data and the face data. Afterward, the virtual reality network performer system 1 can save the environmental parameters P1, the voice changing result P2, the body motion P3 and the face expression P4 in the cloud storage module DB so as to generate the cloud data CD serving as the program data. Via the above operational mechanism, the performer can swiftly and efficiently make a program via the virtual reality network performer system, so the system can satisfy actual requirements.

In addition, the performer can flexibly design the content of his/her own program by the functional modules of the virtual reality network performer system 1 in order to meet the requirements of different types of programs. Thus, the virtual reality network performer system 1 can be more convenient in use and comprehensive in application. Moreover, the virtual reality network performer system 1 can provide additional visual special effects for the character model selected by the performer, so the performer can make the body motion, at a proper moment of the program, corresponding to the special effect trigging condition of the character model in order to trigger the visual special effect corresponding thereto. In this way, the entertainment of the program can be significantly increased.

The embodiment just exemplifies the present invention and is not intended to limit the scope of the present invention; any equivalent modification and variation according to the spirit of the present invention is to be also included within the scope of the following claims and their equivalents.

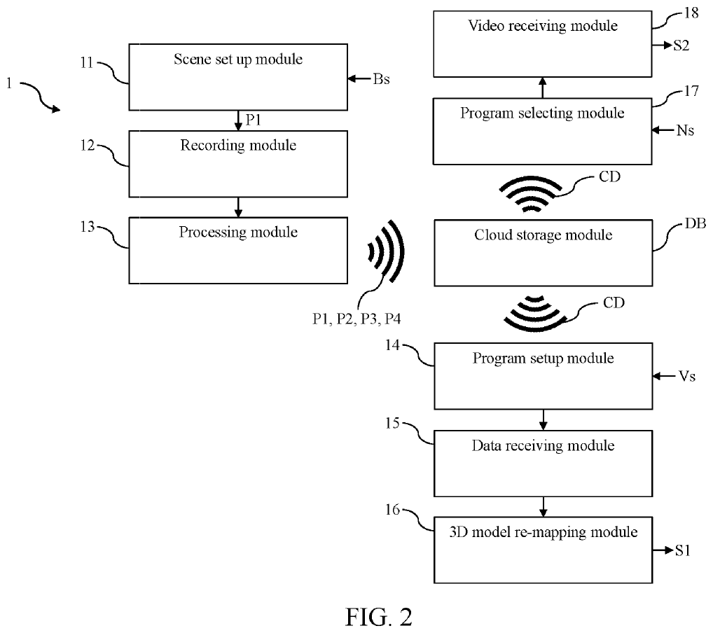

Please refer to FIG. 2, which is a block diagram of a virtual reality network performer system in accordance with another embodiment of the present invention. As shown in FIG. 2, the virtual reality network performer system 1 includes a scene setup module 11, a recording module 12, a processing module 13, a program setup module 14, a data receiving module 15 and a 3D model re-mapping module 16. The above elements are similar to the previous embodiment, so will not be described herein. The difference between this embodiment and the previous embodiment is that the virtual reality network performer system 1 further includes a program selecting module 17 and a video receiving module 18.

The program selecting module 17 receives a program selecting instruction Ns inputted by a normal viewer (the user has not obtained the VIP qualification yet) via his/her electronic device (e.g., smart phone, tablet computer, laptop computer, personal computer, virtual reality headset, augmented reality headset, etc.).

The video receiving module 18 receives the cloud data CD, from the cloud storage module DB, designated by the program selecting instruction Ns in order to generate a second program data S2. Afterward, the video receiving module 18 transmits the second program data S2 to the electronic device (e.g., VR headset, AR headset, etc.) of the normal viewer. Thus, the normal viewer can watch the second program data S2 via his/her electronic device.

As described above, although the normal viewer cannot use other advanced functions, the normal user can still watch the program of the performer via the virtual reality network performer system 1.

It is worthy to point out that there is currently no an effective system for a virtual reality network performer to efficiently make a video program for the viewers to watch. On the contrary, according to one embodiment of the present invention, the virtual reality network performer system can receive the scene setup instruction inputted by a performer in order to set a plurality of environmental parameters, and receive the voice data, the body motion data and the face data of the performer in order to generate a voice changing result, a body motion and a face expression. Then, the virtual reality network performer system saves the environmental parameters, the voice changing result, the body motion and the face expression in the cloud storage module in order to form a cloud data. Via the above operational mechanism, the performer can swiftly and efficiently make a program via the virtual reality network performer system, so the system can satisfy actual requirements.

Also, according to one embodiment of the present invention, the functional modules of the virtual reality network performer system can provide the proper contents for the performer to freely design his/her programs so as to meet the needs of making different types of programs. Therefore, the system can be more convenient in use and comprehensive in application.

Further, according to one embodiment of the present invention, the virtual reality network performer system has a 3-dimensional (3D) model re-mapping module, which can integrate a 3D model with the cloud data so as to generate a program data. As a result, the voice, body motion and face expression of the performer can be effectively integrated with the 3D model in order to achieve great visual effect and improve the experiences of the VIP viewers.

Moreover, according to one embodiment of the present invention, the virtual reality network performer system has a program setup module for the VIP viewers to set performer, donation mode, cheering sound effect, camera mode, screenshot, text outputting, voice outputting, virtual hand interaction mode, location of viewer, sound effect, sound volume, etc. Therefore, the system can provide more functions for the VIP viewers, which can further improve the experiences of the VIP viewers.

Furthermore, according to one embodiment of the present invention, the virtual reality network performer system can provide additional visual special effects for the character model selected by the performer. In this way, the performer can make a body motion conforming to the special effect trigging condition of the character mode selected by the performer with a view to trigger the visual special effect corresponding thereto, which can significantly increase the entertainment of the program. As described above, the virtual reality network performer system according to the embodiments of the present invention can certainly achieve great technical effects.

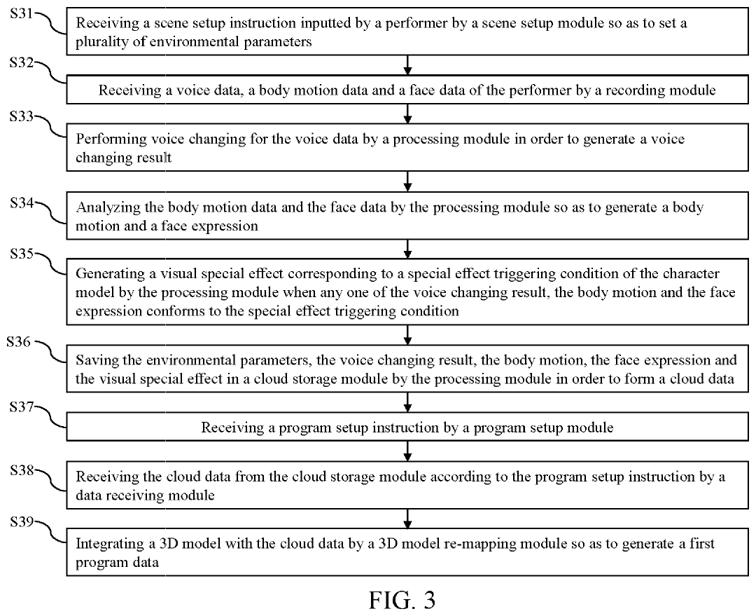

Please refer to FIG. 3, which is a flow chart of a control method of a virtual reality network performer system in accordance with one embodiment of the present invention. The method according to this embodiment includes the following steps:
Step S31: receiving a scene setup instruction inputted by a performer by a scene setup module so as to set a plurality of environmental parameters.
Step S32: receiving a voice data, a body motion data and a face data of the performer by a recording module.
Step S33: performing voice changing for the voice data by a processing module in order to generate a voice changing result.
Step S34: analyzing the body motion data and the face data by the processing module so as to generate a body motion and a face expression.
Step S35: generating a visual special effect corresponding to a special effect triggering condition of the character model by the processing module when any one of the voice changing result, the body motion and the face expression conforms to the special effect triggering condition.
Step S36: saving the environmental parameters, the voice changing result, the body motion, the face expression and the visual special effect in a cloud storage module by the processing module in order to form a cloud data.
Step S37: receiving a program setup instruction by a program setup module.
Step S38: receiving the cloud data from the cloud storage module according to the program setup instruction by a data receiving module.
Step S39: integrating a 3D model with the cloud data by a 3D model re-mapping module so as to generate a first program data.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer (or a processor). As an example, an embodiment of a computer program product includes a computer useable storage medium to store a computer readable program.

The computer useable or computer readable storage medium can be an electronic, magnetic, optical, electromagnetic, infrared, or semiconductor system (or apparatus or device). Examples of non-transitory computer useable and computer readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention (or each module of the system) may be implemented entirely in hardware, entirely in software or in an implementation containing both hardware and software elements. In embodiments which use software, the software may include, but not limited to, firmware, resident software, microcode, etc. In embodiments which use hardware, the hardware may be implemented within one or more application specific integrated circuits (ASICs), digital signal processors (DSPs), digital signal processing devices (DSPDs), programmable logic devices (PLDs), field programmable gate arrays (FPGAs), central-processing unit (CPU), controllers, micro-controllers, microprocessors, electronic devices, other electronic units designed to perform the functions described herein, or a combination thereof.

To sum up, according to one embodiment of the present invention, the virtual reality network performer system can receive the scene setup instruction inputted by a performer in order to set a plurality of environmental parameters, and receive the voice data, the body motion data and the face data of the performer in order to generate a voice changing result, a body motion and a face expression. Then, the virtual reality network performer system saves the environmental parameters, the voice changing result, the body motion and the face expression in the cloud storage module in order to form a cloud data. Via the above operational mechanism, the performer can swiftly and efficiently make a program via the virtual reality network performer system, so the system can satisfy actual requirements.

Also, according to one embodiment of the present invention, the functional modules of the virtual reality network performer system can provide the proper contents for the performer to freely design his/her programs so as to meet the needs of making different types of programs. Therefore, the system can be more convenient in use and comprehensive in application.

Further, according to one embodiment of the present invention, the virtual reality network performer system has a 3-dimensional (3D) model re-mapping module, which can integrate a 3D model with the cloud data so as to generate a program data. As a result, the voice, body motion and face expression of the performer can be effectively integrated with the 3D model in order to achieve great visual effect and improve the experiences of the VIP viewers.

Moreover, according to one embodiment of the present invention, the virtual reality network performer system has a program setup module for the VIP viewers to set performer, donation mode, cheering sound effect, camera mode, screenshot, text outputting, voice outputting, virtual hand interaction mode, location of viewer, sound effect, sound volume, etc. Therefore, the system can provide more functions for the VIP viewers, which can further improve the experiences of the VIP viewers.

Furthermore, according to one embodiment of the present invention, the virtual reality network performer system can provide additional visual special effects for the character model selected by the performer. In this way, the performer can make a body motion conforming to the special effect trigging condition of the character mode selected by the performer with a view to trigger the visual special effect corresponding thereto, which can significantly increase the entertainment of the program.

In one embodiment of the present invention, the virtual reality network performer system can provide a special operational mechanism for the performer to swiftly and efficiently make his/her programs, which can meet the development trend in the future and the demand of this industry. Accordingly, the system can have high commercial value.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A virtual reality network performer system, comprising:
a scene setup module configured to receive a scene setup instruction inputted by a performer in order to set a plurality of environmental parameters;
a recording module configured to receive a voice data, a body motion data and a face data of the performer; and
a processing module configured to perform a voice changing for the voice data to generate a voice changing result, and analyze the body motion data and the face data to generate a body motion and a face expression, and then save the environmental parameters, the voice changing result, the body motion and the face expression in a cloud storage module in order to form a cloud data.

2. The virtual reality network performer system as claimed in claim 1, wherein the environmental parameters comprise a background, a character model, a background music, an incidental music, a sound effect, a special effect, a location of a viewer, a viewing angle of the viewer and an interaction mode.

3. The virtual reality network performer system as claimed in claim 2, wherein when the processing module determines that any one of the voice changing result, the body motion and the face expression conforms to a special effect triggering condition of the character model, the processing module generates a visual special effect corresponding to the special effect triggering condition.

4. The virtual reality network performer system as claimed in claim 1, further comprising a program setup module, a data receiving module and a 3-dimensional (3D) model re-mapping module, wherein the program setup module is configured to receive a program setup instruction, and the data receiving module receives the cloud data from the cloud storage module according to the program setup instruction, wherein the 3D model re-mapping module is configured to integrate a 3D model with the cloud data so as to generate a first program data.

5. The virtual reality network performer system as claimed in claim 1, further comprising a program selecting module and a video receiving module, wherein the program selecting module is configured to receive a program selecting instruction and the video receiving module is configured to receive the cloud data from the cloud storage module according to the program selecting instruction in order to generate a second program data.

6. A control method for a virtual reality network performer system, comprising:
receiving a scene setup instruction inputted by a performer by a scene setup module so as to set a plurality of environmental parameters;
receiving a voice data, a body motion data and a face data of the performer by a recording module;
performing a voice changing for the voice data by a processing module in order to generate a voice changing result;
analyzing the body motion data and the face data by the processing module so as to generate a body motion and a face expression; and
saving the environmental parameters, the voice changing result, the body motion and the face expression in a cloud storage module by the processing module in order to form a cloud data.

7. The control method for the virtual reality network performer system as claimed in claim 6, wherein the environmental parameters comprise a background, a character model, a background music, an incidental music, a sound effect, a special effect, a location of a viewer, a viewing angle of the viewer and an interaction mode.

8. The control method for the virtual reality network performer system as claimed in claim 7, further comprising:
generating a visual special effect corresponding to a special effect triggering condition of the character model by the processing module when any one of the voice changing result, the body motion and the face expression conforms to the special effect triggering condition.

9. The control method for the virtual reality network performer system as claimed in claim 6, further comprising:
receiving a program setup instruction by a program setup module;
receiving the cloud data from the cloud storage module according to the program setup instruction by a data receiving module; and
integrating a 3D model with the cloud data by a 3D model re-mapping module so as to generate a first program data.

10. The control method for the virtual reality network performer system as claimed in claim 6, further comprising:
receiving a program setup instruction by a program setup module; and
receiving the cloud data from the cloud storage module according to the program setup instruction by a video receiving module in order to generate a second program data.
